(19) United States
(12) Patent Application Publication
(10) Pub. No.: US 2004/0147255 A1
(43) Pub. Date: Jul. 29, 2004

(54) Method for restricting additional function of multifunctional mobile communication terminal

(75) Inventor: Dong-Kyu Lee, Puchon-shi (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., GYEONGGI-DO (KR)

(21) Appl. No.: 10/756,791

(22) Filed: Jan. 12, 2004

(30) Foreign Application Priority Data
Jan. 14, 2003 (KR) 2447/2003

(51) Int. Cl. H04M 1/00

(52) U.S. Cl. 455/422.1; 455/552.1; 455/435.2

(57) ABSTRACT

Disclosed is a method for restricting an additional function of a multifunctional mobile communication terminal according to each terminal in private mobile communication service area. A public/private communication service apparatus stores information of multifunctional mobile communication terminals being provided with the private mobile communication service and information on whether or not each of the terminals is allowed to use the additional function in the public/private shared cell area, and then checks whether or not the located terminal is a terminal being provided with private mobile communication service and whether or not the located terminal is allowed to use an additional function while location registration of a multifunctional mobile communication terminal is proceeding. According to the result, the public/private communication service apparatus transmits a location registration response message to the multifunctional mobile communication terminal inclusive of a code which represents whether or not to restrict the additional function of the multifunctional mobile communication terminal.

### PRIORITY

This application claims priority to an application entitled “Method for Restricting Additional Function of Multifunctional Mobile Communication Terminal” filed in the Korean Industrial Property Office on Jan. 14, 2003 and assigned Serial No. 2003-2447, the contents of which are hereby incorporated by reference.

### BACKGROUND OF THE INVENTION

1. Field of the Invention

The present invention relates to a multifunctional mobile communication terminal and, more particularly, to a method for restricting an information store function of a multifunctional mobile communication terminal in a private mobile communication network.

2. Description of the Related Art

Recently, with the development of mobile communication technology, a variety of multifunctional mobile communication terminals (hereinafter, referred to as “multifunctional terminals”), which have at least one additional function in addition to the basic call function, such as a TV phone enabling users to watch TV, a PDA phone having PDA function, and a camera phone mounted with a camera and having a moving picture store function, have been developed. At the same time, the importance of information security is rising with the advent of an information-oriented society, so that security in business is being recognized as a very important subject. Thus, in order to prevent secret information from being photographed or downloaded, several companies ban visitors from entering with a camera and/or a notebook computer. However, in case of the multifunctional terminal, a visitor may clandestinely take the terminal onto a company premises without any restraint because of the small size of it. Among the problems this creates is that of preventing the company's secret information from being photographed or downloaded by the multifunctional terminal that is stealthily carried in.

Therefore, it is necessary to restrict some functions of the terminal having multiple functions in some areas, especially in some security areas. For example, a photographing function may be disabled in a camera phone or data download function may be restricted in a PDA phone.

### SUMMARY OF THE INVENTION

Accordingly, the present invention has been made to solve the above-mentioned problems occurring in the prior art, and an object of the present invention is to provide a method for restricting an additional function of a multifunctional mobile communication terminal in order to restrict the use of additional functions in a security area.

Another object of the present invention is to provide a method for restricting an additional function of a multifunctional mobile communication terminal in order to restrict the use of a photograph function in a special area such as a security area.

Another object of the present invention is to provide a method for restricting an additional function of a multifunctional mobile communication terminal in order to restrict the use of an information data download function in a special area.

In order to accomplish these objects, there is provided a method for restricting an additional function of a multifunctional mobile communication terminal having an additional function other than a basic call function in a public/private shared cell area which is supported by public and private mobile communication services, the method being performed by a public/private communication service apparatus, the method comprising the steps of: storing a first information, the first information including information of multifunctional mobile communication terminals being provided with the private mobile communication service and information on whether or not each of the terminals is allowed to use the additional function in the public/private shared cell area; transmitting a system parameter message to a multifunctional mobile communication terminal being located in the public/private shared cell area, and receiving a location registration request message including a second information, the second information indicating that the located terminal corresponds to the system parameter message and has the additional function; and checking whether or not the located terminal is a terminal being provided with private mobile communication service and whether or not the located terminal is allowed to use the additional function in the public/private shared cell area when the apparatus has received the location registration request message, and transmitting a location registration response message including an additional function restriction code to the located terminal if the located terminal is a terminal restricted from using the additional function.

Preferably, the method further comprises a step of setting a mode restricting the execution of the additional function, when the multifunctional mobile communication terminal has received the location registration response message.

### BRIEF DESCRIPTION OF THE DRAWINGS

The above and other objects, features and advantages of the present invention will be more apparent from the following detailed description taken in conjunction with the accompanying drawings, in which:

FIG. 1 is a constructional view of a mobile communication system according to the present invention;

FIG. 2 is a block diagram of a multifunctional mobile communication terminal that can be utilized with the present invention;

FIG. 3 is a table of a location registration message according to the present invention;

FIG. 4 is illustrates a flow of messages according to the present invention;

FIG. 5 is a flowchart illustrating the operation of the multifunctional mobile communication terminal according to an embodiment of the present invention; and

FIG. 6 is a flowchart illustrating the operation of the multifunctional mobile communication terminal according to another embodiment of the present invention.

### DETAILED DESCRIPTION OF THE PREFERRED EMBODIMENTS

Hereinafter, a method for restricting an additional function of a multifunctional mobile communication terminal according to preferred embodiments of the present invention will be described with reference to the accompanying drawings. In the following description of the present invention, a detailed description of known functions and configurations incorporated herein will be omitted to avoid making the subject matter of the present invention unclear.

The present invention is for restricting the use of additional functions included in a multifunctional mobile communication terminal (hereinafter, referred to as “multifunctional terminal”) according to whether the multifunctional terminal is located within a mobile communication service area of a private network. A public/private communication service apparatus will have previously registered information regarding a plurality of multifunctional terminals, specifically, whether or not each multifunctional terminal is a terminal provided with private mobile communication service, and whether or not each multifunctional terminal can use additional functions. Thus, when the location registration of a multifunctional terminal is executed, the public/private communication service apparatus checks whether or not the multifunctional terminal is a terminal provided with private mobile communication services, and whether or not the multifunctional terminal can use additional functions. According to the result of the check, the public/private communication service apparatus transmits a location registration response message, including a function restriction code, to the multifunctional terminal. Then, a function restriction mode of the multifunctional terminal is set in accordance with the function restriction code included in the location registration response message.

Description will be made in detail below regarding preferred embodiments of the present invention. A first embodiment will be described in which the multifunctional terminal is a mobile communication terminal having a digital photograph function which is restricted from being or is not authorized to be used in a private mobile communication service area. There are many methods for restricting a photograph function, and the first embodiment refers to the method for restricting storage of photographed image data. The storage restriction preferably restricts the ability to store photographed image data in the memory of the multifunctional terminal, as well as the ability to upload photographed image data for remote storage.

A description of a second embodiment will follow in which the multifunctional terminal is a mobile communication terminal having a PDA function. The mobile communication terminal having the PDA function can upload or download a large quantity of data, so a method restricting the store function of data, which is inputted through a data input port, will be used in order to restrict the additional function like the first embodiment.

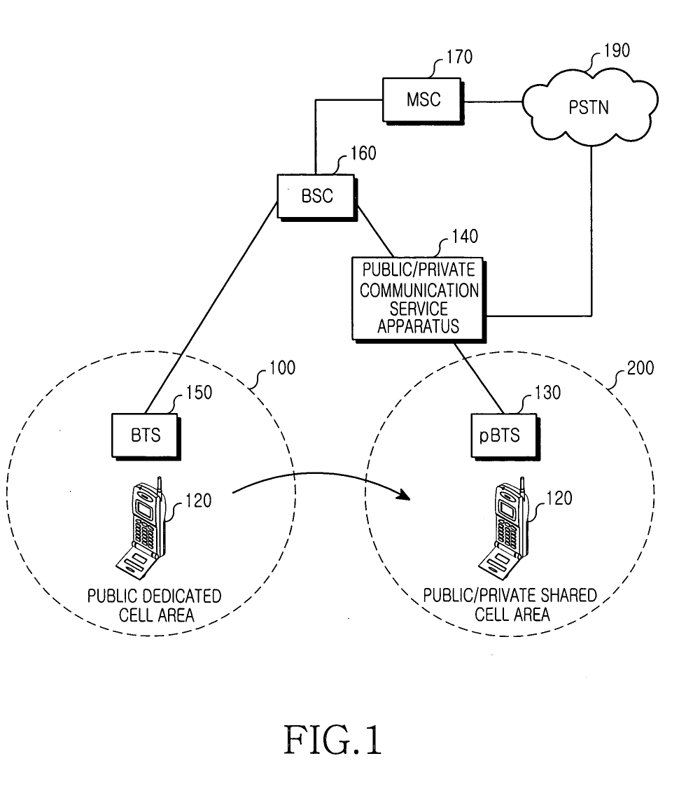

Hereinafter, the present invention will be described in detail with reference to FIGS. 1 to 6.

Referring to FIG. 1, a mobile communication system construction applied to the present invention will be described. FIG. 1 is a constructional view of a mobile communication system according to the present invention. In order to provide both the public and private mobile communication services, the mobile communication system, as shown in FIG. 1, has a public/private shared cell area 200 that is a public and private common communication service zone, and is provided with a public/private communication service apparatus 140. It is preferred that the public/private shared cell area 200 is determined for the convenience of a specified group in providing a communication service. For instance, if it is assumed that when a specified company uses a building, an area to which the building belongs may be determined as the public/private shared cell area 200. It is preferred that determination of the public/private shared cell area 200 is made upon advance deliberation with a public mobile communication service provider. In this case, a private base transceiver station (hereinafter, referred to as a “private BTS”) 130 in the public/private shared cell area 200 can be recognized as one public base transceiver station from a viewpoint of the public mobile communication system. The private BTS 130 is in radio communication with a multifunctional terminal 120 in the public/private shared cell area 200, and performs a function of managing radio resources. Also the private BTS 130 is connected to a base station controller (BSC) 160 through the public/private communication service apparatus 140.

The public/private communication service apparatus 140 is connected to the BSC 160 and a PSTN (Public Switched Telephone Network) 190 of the public mobile communication system. The public/private communication service apparatus 140 performs the mobile communication service so that the public and private mobile communication services can be selectively provided to multifunctional terminal 120 in the public/private shared cell area 200. If the multifunctional terminal 120 is registered in the public/private communication service apparatus 140 so that it can receive the private mobile communication service, the multifunctional terminal 120 can receive the private mobile communication service in addition to the public mobile communication service. However, if the multifunctional terminal 120 is not registered in the public/private communication service apparatus 140, the multifunctional terminal 120 can receive only the public mobile communication service. Also, the public/private communication service apparatus 140 performs a wire communication service with the PSTN 190, this is also true of the multifunctional terminal 120 according to embodiments of the present invention.

The multifunctional terminal 120 is a terminal having an additional function in addition to the basic call function. Examples of the multifunctional terminal 120 are a TV phone enabling users to watch TV, a PDA phone having a PDA function, a camera phone mounted with a camera and having a moving picture store function, and so forth. The first embodiment refers to a camera phone mounted with a camera and having a moving picture store function, and the second embodiment refers to the PDA phone having PDA function.

According to the first embodiment, the multifunctional terminal 120 (hereinafter, referred to as “camera phone 120”), which has been registered in the public/private communication service apparatus 140 so that it can receive the private mobile communication service, is also registered regarding whether or not the camera phone 120 is a terminal which can use an additional function in a public/private shared cell area 200. That is, when the camera phone 120 enters the public/private shared cell area 200 and performs a location registration, the public/private communication service apparatus 140 checks whether the camera phone 120 is a terminal authorized to receive the private mobile communication and whether or not the camera phone 120 is allowed to execute an additional function in the public/private shared cell area 200. According to the result of the check, the public/private communication service apparatus 140 transmits an approval message or a restriction message regarding the additional function execution to the camera phone 120. In other words, the public/private communication service apparatus 140 checks whether the camera phone 120 is a terminal allowed to use a photograph function in the public/private shared cell area 200. As the result of the check, if it is confirmed that the camera phone 120 is a terminal not allowed to use a photograph function, the public/private communication service apparatus 140 transmits a restriction message to the camera phone 120 in order to restrict the additional function execution.

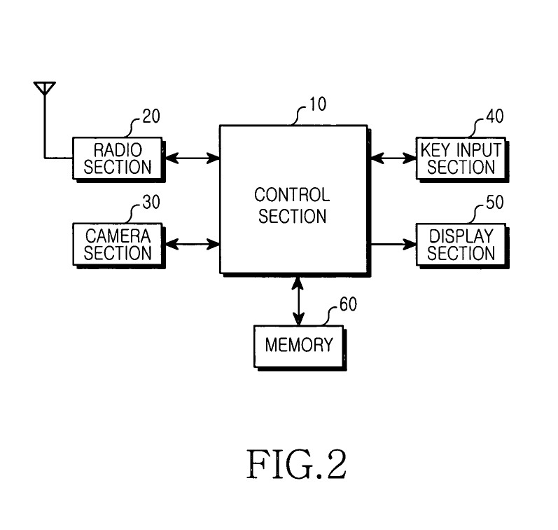

FIG. 2 is a block diagram of a multifunctional mobile communication terminal that can be utilized with the present invention. Referring to FIG. 2, The camera phone 120 includes a control section 10, a radio section 20, a camera section 30, a key input section 40, a display section 50, and a memory 60. The control section 10 controls the camera phone 120. The key input section 40 has a plurality of number keys and function keys, outputs key input data to the control section 10 in accordance with the key pressed by a user. The radio section 20 modulates and demodulates radio signals including voice data or control data, which have been received through an antenna, under the control of the control section 10, and outputs the modulated/demodulated signals. The display section 50 displays a variety of messages under the control of the control section 10. The camera section 30 divides an image into digitized data, e.g. bit map format, recording each bit's luminance by the digital amount, and stores a photographed image in the memory 60. The memory 60 stores program data needed for the operation control of camera phone 120, data generated under the operation control or during user's operation performance, image data transmitted from the camera section 30.

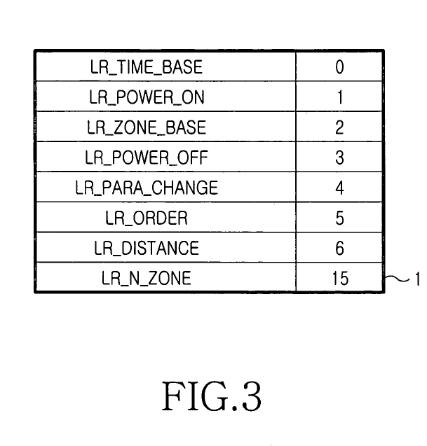

When the camera phone 120 which has the above construction enters the public/private shared cell area 200 from a public dedicated cell area 100 as shown in FIG. 1, the camera phone 120 receives a system parameter message from the private BTS 130. Generally, the system parameter message is broadcast throughout in the whole service area of a BTS through a paging channel, the private BTS 130 of the public/private shared cell area 200 transmits the system parameter message including information data which represents that the present location is in the public/private shared cell area 200. If the camera phone 120, which has received the system parameter message, is a terminal enabled to receive the private mobile communication service, the camera phone 120 transmits a location registration message such as that shown in FIG. 3 in addition to a conventional location registration message to the public/private communication service apparatus 140. FIG. 3 is a table of a location registration message according to the present invention. Therefore, when the public/private communication service apparatus 140 receives the location registration message, the public/private communication service apparatus 140 checks whether the camera phone 120 is registered for receiving the public mobile communication service in the public/private shared cell area 200.

Also, ADD Function field being 2 bits is added to the LR_N_ZONE (field 1 of FIG. 3) of the location registration message so that the location registration message can include information data which represents that the camera phone 120 has an additional function, that is, a photograph function. Therefore, when the public/private communication service apparatus 140 receives the location registration message, the public/private communication service apparatus 140 checks whether or not the camera phone 120 is a terminal allowed to use the additional function in the public/private shared cell area 200. If the camera phone 120 is a terminal which is allowed to use the photograph function, the public/private communication service apparatus 140 transmits the location registration response message (feature notification message) including a use permit code for the photograph function.

However, if the camera phone 120 is a terminal which is not allowed to use the photograph function, the public/private communication service apparatus 140 transmits a location registration response message including a use restriction code for the photograph function. There are many known methods for restricting the photograph function, and the first embodiment of the present invention utilizes the method for restricting the right to store data outputted through a photograph of the camera. That is, if the camera phone 120 receives a location registration response message including the use restriction code for the photograph function, the camera phone 120 is set to a data store restriction mode. After this, though the camera phone 120 photographs an image, the data of the photographed image are not stored.

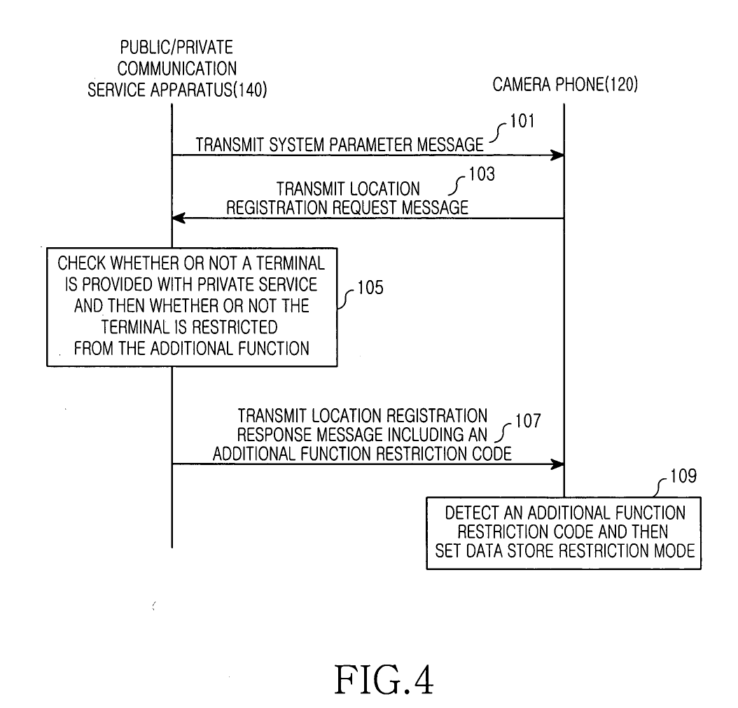

A flow of messages according to the operation process of the present invention is illustrated in FIG. 4. Referring to FIG. 4, when the camera phone 120 enters a public/private shared cell area 200, the camera phone 120 receives the system parameter message transmitted from the public/private communication service apparatus 140 at step 101. The camera phone 120 recognizes the present location area as a private mobile communication service area by the system parameter message, and transmits a location registration request message to the public/private communication service apparatus 140 at step 103. Then, the location registration request message includes information which represents whether the camera phone 120 has an additional function, that is, a photograph function.

The public/private communication service apparatus 140, which has received the location registration request message, checks whether or not the camera phone 120 is a terminal receiving the private mobile communication service and whether or not the camera phone 120 is a terminal that is restricted from the execution of the additional function at step 105. If through checking it is confirmed that the camera phone 120 is a terminal that is restricted from the additional function execution, the public/private communication service apparatus 140 transmits a location registration response message including an additional function restriction code to the camera phone 120 at step 107. Then, the additional function restriction code is expressed by using a CHARi bit of the conventional location registration response message. If the camera phone 120, for example, belongs to the public/private shared cell area 200 and is restricted from the additional function execution, the value of the CHARi bit is Oxff. If the camera phone 120 belongs to the public/private shared cell area 200 and is not restricted from the additional function execution, the value of the CHARi bit is Oxfe. If the camera phone 120 doesn't belong to the public/private shared cell area 200 and is restricted from the additional function execution, the value of the CHARi bit is Oxfd. If the camera phone 120 doesn't belong to the public/private shared cell area 200 and is not restricted from the additional function execution, the value of the CHARi bit is Oxfc.

After the step 107, the camera phone 120 detects the additional function restriction code and is set to the data store restriction mode at step 109.

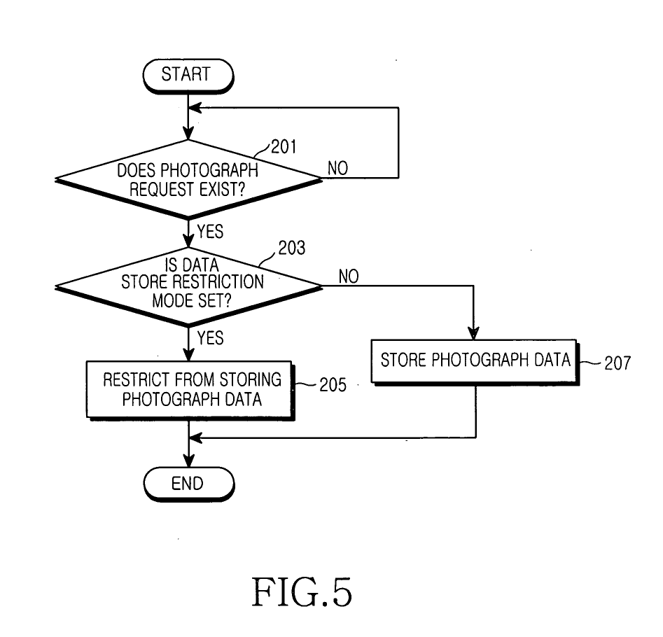

In the public/private shared cell area 200, the operation process of the camera phone 120, whose information store mode has been set by the process described above, is described with reference to FIG. 5. FIG. 5 is a flowchart illustrating the operation of the camera phone 120 according to the first embodiment of the present invention. The camera phone 120, which is located in the public/private shared cell area 200, checks whether or not a request for a photograph exists at step 201, if it is confirmed that a request for a photograph exists as a result of checking at step 201, the camera phone 120 proceeds to step 203. At step 203, the camera phone 120 checks whether or not the data store restriction mode has been set.

If through checking of step 203 it is confirmed that the camera phone 120 has been set to the data store restriction mode, the camera phone 120 proceeds to step 205, however if it is confirmed that the camera phone 120 has not been set to the data store restriction mode, the camera phone 120 proceeds to step 207. At step 205, the camera phone 120 terminates the photograph store function without operating a storing function for photographed image data. However, at step 207, the camera phone 120 stores photographed image data and then terminates the photograph store function.

Hereinafter, the second embodiment will be described in regard to a case in which the multifunctional terminal 120 is a PDA phone. Having entered a public/private shared cell area 200, the PDA phone recognizes that the present location area is a private mobile communication service area from the system parameter message and transmits a location registration request message to the public/private communication service apparatus 140. The location registration request message includes information which represents that the PDA phone has a PDA function as an additional function. The public/private communication service apparatus 140, which has received the location registration request message, checks whether or not the PDA phone is a terminal that is restricted from the execution of the additional function, if the PDA phone is confirmed as a terminal receiving the private mobile communication service. As a result of checking, if it is confirmed that the PDA phone is a terminal that is restricted from the additional function execution, the public/private communication service apparatus 140 transmits a location registration response message including an additional function restriction code to the PDA phone. Receiving the additional function restriction code, the PDA phone is set to the data store restriction mode.

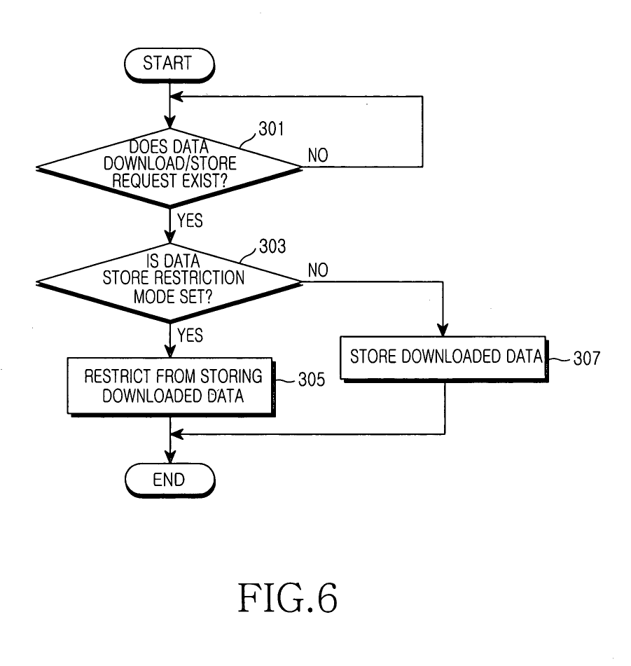

The PDA phone, in which the data store restriction mode of which is set by the process as above, operates as shown in FIG. 6. FIG. 6 is a flowchart illustrating the operation of the PDA phone according to the second embodiment of the present invention. Referring to FIG. 6, the PDA phone, which is located in the public/private shared cell area 200, checks whether or not a request for downloading/storing exists at step 301, if it is confirmed that a request for downloading/storing exists as a result of checking at step 301, the PDA phone proceeds to step 303. At step 303, the PDA phone checks whether or not the data store restriction mode has been set. If through step 303 it is confirmed that the PDA phone has been set to the data store restriction mode, the PDA phone proceeds to step 305. However if it is confirmed that the PDA phone has not been set to the data store restriction mode, the PDA phone proceeds to step 307. At step 305, the PDA phone terminates the data store function without storing downloaded data. However, at step 307, the PDA phone stores downloaded data and then terminates the data store function.

As described above, on performing the location registration of a multifunctional mobile communication terminal, the public/private communication service apparatus according to the present invention checks whether or not the terminal is allowed to receive the private mobile communication service and whether or not the terminal is restricted from additional function execution, and selectively restricts additional functions of the multifunctional mobile communication terminal, so that the present invention has the advantage of improving security in a special area.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for restricting a function of a multifunctional mobile communication terminal having at least one additional function other than a basic call function in a public/private shared cell area which is supported by public and private mobile communication services, the method comprising the steps of:
storing a first information indicating whether the multifunctional mobile communication terminal is provided with a private mobile communication service and whether the terminal is allowed to use an additional function in the public/private shared cell area;
transmitting a system parameter message to the multifunctional mobile communication terminal located in the public/private shared cell area, and receiving a location registration request message which includes a second information indicating whether the located terminal corresponds to the system parameter message and has the additional function; and
checking whether the located terminal is a terminal being provided with the private mobile communication service and whether the located terminal is allowed to use the additional function in the public/private shared cell area when the apparatus has received the location registration request message, and transmitting a location registration response message including an additional function restriction code to the located terminal if the located terminal is a terminal restricted from using the additional function.

2. The method as claimed in claim 1, wherein the method is performed by a public/private communication service apparatus,

3. The method as claimed in claim 1, further comprising a step of the located terminal setting a mode restricting the execution of the additional function depending on an interpretation of the additional function restriction code, when the located terminal has received the location registration response message from the apparatus.

4. The method as claimed in claim 1, wherein the additional function restriction code is a code for restricting a digital image photograph function.

5. The method as claimed in claim 3, wherein the additional function restriction mode is a mode for restricting use of a digital image photograph function.

6. The method as claimed in claim 5, wherein the additional function restriction mode is a mode for restricting storage of data generated by a digital photograph.

7. A method for restricting a function of a multifunctional mobile communication terminal in a mobile communication system, which includes terminals and a public/private communication service apparatus, each terminal having at least one additional function other than a basic call function, the apparatus already having stored a first information regarding whether the terminals are provided with a private mobile communication service and whether each of the terminals is allowed to use an additional function in a public/private shared cell area supported with public and private mobile communication services, the apparatus also transmitting an additional function restriction code to terminals restricted from using the additional function, the method being performed by the multifunctional mobile communication terminal, the method comprising the steps of:
transmitting a location registration request message including a second information to the apparatus when the multifunctional mobile communication terminal is located in the public/private shared cell area, the second information representing whether the located terminal has the additional function corresponding to a system parameter message transmitted from the apparatus; and
setting a mode restricting the execution of the additional function, when the located terminal has received a location registration response message including the additional function restriction code from the apparatus.

8. A method in a multifunctional mobile communication terminal for restricting a downloading/storing data function for data provided from other terminals in a public/private shared cell area which is supported by public and private mobile communication services, the method comprising the steps of:
storing a first information in a public/private communication service apparatus indicating whether the multifunctional mobile communication terminal is provided with a private mobile communication service and whether the terminal is allowed to use the download/store function in the public/private shared cell area;
transmitting a location registration request message by the multifunctional mobile communication terminal including a second information to the apparatus, when the multifunctional mobile communication terminal is located in the public/private shared cell area, wherein the second information represents whether the download/store function of the located terminal corresponds to a system parameter message transmitted from the apparatus;
checking by the public/private communication service apparatus whether the located terminal is a terminal provided with the private mobile communication service and whether the located terminal is allowed to use the download/store function in the public/private shared cell area when the apparatus has received the location registration request message, and transmitting a location registration response message including an additional function restriction code to the located terminal if the located terminal is a terminal restricted from using the download/store function; and
setting a mode restricting the function for downloading and storing data from other terminals in the located terminal, when the located terminal has received the location registration response message and the first information identifies that the multifunctional mobile communication terminal is not allowed to use the download/store function in the public/private shared cell area.

9. A method for restricting a function of a multifunctional mobile communication terminal in a mobile communication system, which includes terminals and a public/private communication service apparatus, each terminal having a function for downloading/storing data provided from other terminals, the apparatus already having stored a first information representing the terminals provided with a private mobile communication service and whether the terminal is allowed to use the download/store function in a public/private shared cell area which supports public and private mobile communication services, the apparatus also transmitting an additional function restriction code to terminals restricted from using the download/store function, the method being performed by the multifunctional mobile communication terminal, the method comprising the steps of:
transmitting a location registration request message including a second information to the apparatus when the multifunctional mobile communication terminal is located in the public/private shared cell area, the second information representing whether the located terminal has the download/store function corresponding to a system parameter message transmitted from the apparatus; and
setting a mode restricting the function for downloading and storing data from other terminals when the located terminal has received a location registration response message including the additional function restriction code from the apparatus.
